(19) United States
(12) Patent Application Publication
(10) Pub. No.: US 2011/0022244 A1
(43) Pub. Date: Jan. 27, 2011

(54) Control Arrangement and Method for Controlling an Energy Load

(75) Inventor: Jim O'Callaghan, Cottonwood Heights, UT (US)

Correspondence Address: COHEN, PONTANI, LIEBERMAN & PAVANE LLP, 551 FIFTH AVENUE, SUITE 1210, NEW YORK, NY, 10176, US

(73) Assignee: EnOcean GmbH, Oberhaching (DE)

(21) Appl. No.: 12/811,367

(22) PCT Filed: Dec. 29, 2008
(86) PCT No.: PCT/EP08/11134

§ 371 Date: Oct. 4, 2010

Related U.S. Application Data
(60) Provisional application No. 61/009,685, filed on Dec. 31, 2007.

(51) Int. Cl. G06F 1/26

(52) U.S. Cl. 700/297

(57) ABSTRACT

A control arrangement is provided with:
a transmitting device (10) and a receiving device (20). The receiving device (20) has a receive unit (5), a control device (6), and an energy consumer (7) and the transmitting device (10) has an energy converter (2), which converts primary energy into electrical energy, and a supplying device (12, 13; 18), which supplies the primary energy to the energy converter, and a transmit unit (3). The converted energy is provided for operating the transmit unit, which transmits information to the receiving device, and wherein the supplying device can be activated by means of a key device (11) and the receiving device (5) is connected to the control device (6) and the energy load (7), such that the control device (6) controls the energy consumption of the energy load (7) based on the reception of the information.

The invention relates to a control arrangement and to a method for controlling energy consumption. Today, for example, in hotels it is typical for a guest to find in the entry of his hotel room a central light switch, with which all of the lighting of the hotel room can be turned on and off. Devices are also known, for which the heating or air conditioning system is activated or deactivated simultaneously.

A disadvantage of such central switches is the high wiring expense or the fact that when the hotel guest forgets to turn off the switch when leaving the hotel room, the energy load remains on.

A control arrangement is provided with coordinated claims H1. Thus the invention is based on the task of providing a control arrangement or a method for controlling energy consumption, which reliably guarantees control with simple means.

In particular, because primary energy is supplied to an energy converter with a key device, it is possible to operate in an energy self-supporting way, that is, without line voltage supply and also without the use of a battery, a radio transmitter, which leads to, on the reception side, a regulation of the energy consumption at the load. Here, regulating the energy consumption means both the pure on and off switching of the load and also increasing or reducing to a predetermined consumption value that is different from 0 and that is different from the possible maximum value.

Especially when the transmitting device has a locking device, it is possible, through the key assignment, to guarantee that the energy consumption is controlled only by an authorized person. By providing an electromechanical energy converter, it is possible, for example, to obtain electrical energy through the insertion of the key device into the locking device, from the mechanical energy corresponding to the motion. Here, it can be advantageous if, through the use of an electromagnetic energy converter, the mechanical energy is first converted into magnetic energy and only then into electrical energy. In an alternative, it is possible to convert the mechanical energy into electrical energy via a piezoelectric element. In the receiving device, it is possible for the control device to control the energy consumption, such that it controls the supplied energy or such that the energy consumption is controlled by controlling the demand at the load. In this way, it is advantageous if a sensor device is provided, which supplies a control parameter, on whose basis the control device controls the energy consumption.

Furthermore, it is advantageous if the locking device has a reading device, with which information stored electronically in the key device can be read, because in this way, the authorization can be checked. Alternatively, the presence of a mechanical lock on the locking device is easily possible, so that activation of the supplying device is prevented by a non-authorized key device, so that unauthorized control of the energy consumption can be easily stopped.

In particular, through the presence of a mechanical lock, the generation of electrical energy in the transmitting device for an unauthorized user can be prevented. Alternatively, it is possible that the authorization can be checked in an electronic way by reading out information stored in the key device by means of a reading device in the transmitting device, so that preparation of information for transmission or transmission as such can be easily prevented.

On the receiver side, this means that, on one hand, through the reception of the information, the authorization can be presumed and thus control of the energy consumption is permitted, on the other hand, that the authorization can be derived from the received information only after controlling the energy consumption. Here, it is also possible for the received information to contain a value, at which the energy consumption is to be set or when information is received, for the energy consumption to also be controlled at a value set in the control device.

The individual features presented at first generally were described as alternatives above, but it is easy to understand that they can also be used in combination. Thus it is possible for a mechanical lock to be provided, which allows only certain key devices to be used for activating the supply device, so that, in detail, by reading out information stored in a chip in the key device, the actual authorization can be checked. In this form, it is easy to see that alternatively appearing features can be effectively combined with each other within the collective solution concept of the invention.

Below, embodiments are explained in more detail with reference to the drawings. Identical reference symbols here describe identical objects, wherein the representations are neither true to scale nor true to detail.

Shown are:

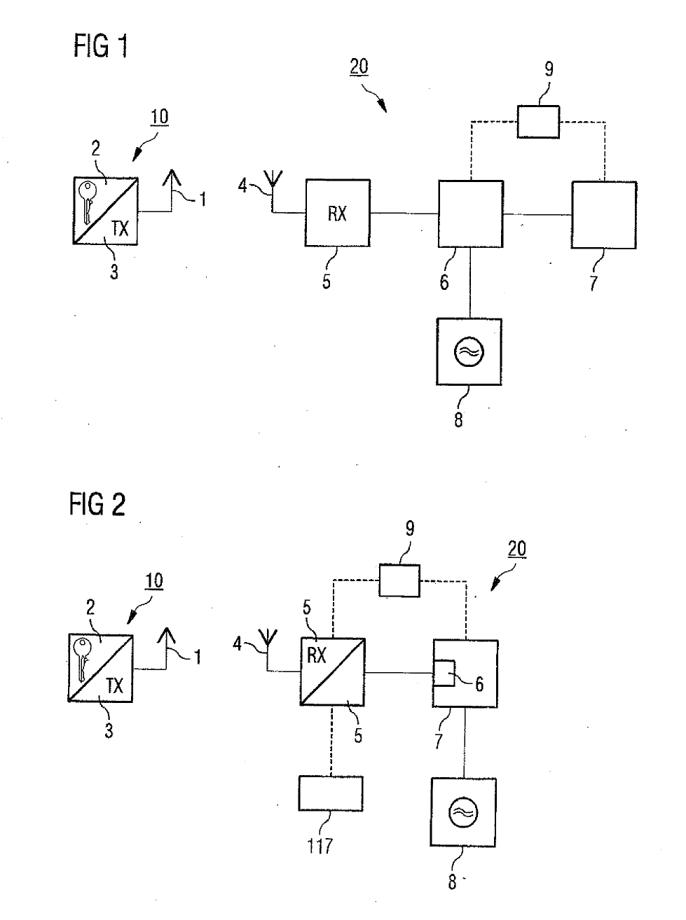

FIG. 1 an embodiment of a control device,

FIG. 2 another embodiment of a control arrangement,

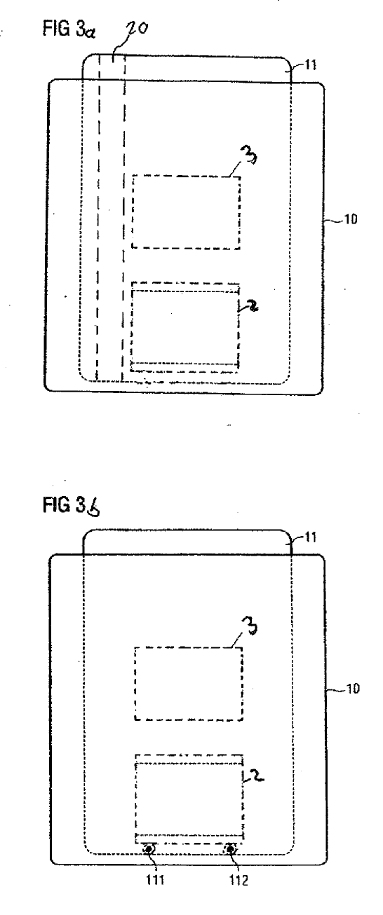

FIGS. 3a, 3b block diagrams of a locking device and key device,

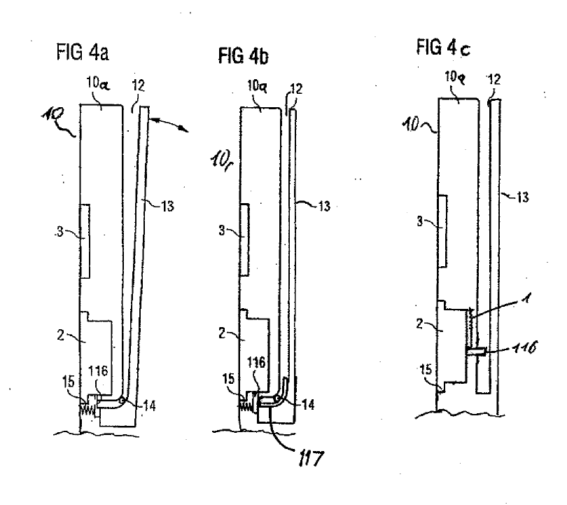

FIGS. 4a, 4b, 4c constructions of a transmitting device,

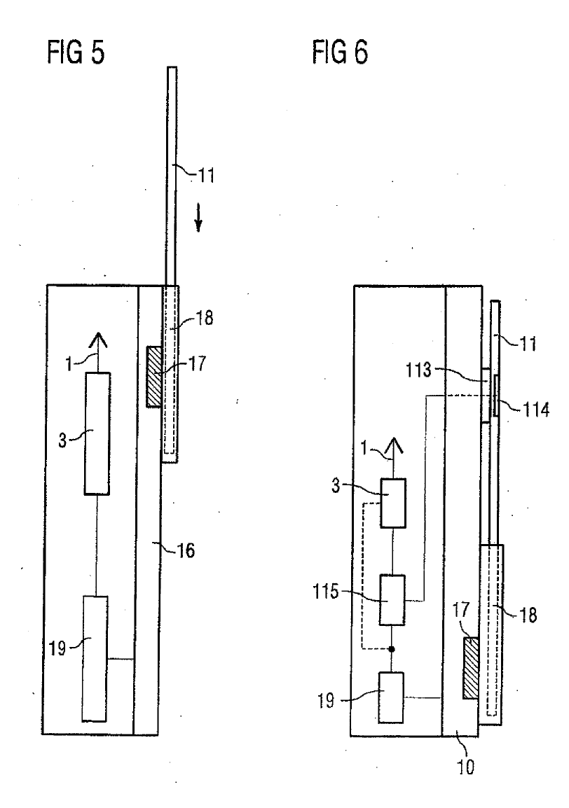

FIG. 5 another construction of a transmitting device, and

FIG. 6 an improvement in the construction of the transmitting device shown in the figure.

In FIG. 1, a block diagram with a transmitting device 10 and a receiving device 20 is shown. The transmitting device 10 is provided with an energy converter 2, a transmit unit 3, and an antenna device 1. The key symbol indicates that the energy converter 2 can be activated by a key device, which will be discussed in detail below. The receiving device 20 has a receive antenna device 4, a receive unit 5, and a control device 6. The control device 6 is connected to an energy source 8 and an energy load 7. The control device 6 controls the energy supply to the energy load 7 based on a received signal.

As an option, a sensor element 9 is shown, which is connected, as shown via dashed lines, on one hand, to the control device 6 and, on the other hand, to the energy load 7. This means that the sensor element optionally transmits to the control device 6 or to the load 7 or also to both a value of a monitored parameter, which is used as a basis for the control. Here there are the following possibilities. The control device 6 controls the energy consumption based on the signal received by the sensor device 9 or at the energy load the consumption of the energy supplied by the control device 6 is consumed based on the value received by the sensor device or both procedures take place. Thus, it is easy to see that it is possible in this way for someone skilled in the art to regulate the energy consumption as an improvement of the control. Obviously, several sensors are also conceivable, which are supplied to the control device and/or to the energy load.

When the energy load 7 was mentioned in general above, at this point it should be noted that this can be an electrical energy load, such as one or more lamps, which are switched on or off by the control device 6 or which are increased or reduced to a certain illuminating value. The supplied energy is here electrical energy. As an energy load 7, an air-conditioning system is just as easy to imagine alternatively or additionally, wherein here electrical energy is also provided here as energy, whose consumption is controlled. Here, a temperature sensor can be provided as a sensor, so that the energy supplied to the air-conditioning system is set at a predetermined value or the consumption of the air-conditioning system is set accordingly. Where an air-conditioning system was used as an example of the energy load 7 above, it should also be mentioned that not only the cooling of a room temperature is meant as the air-conditioning system, but also the heating. In such a case, for an electrical heating device, the supplied energy is also electrical energy, but other known heating devices can also be used, so that the control element includes the function of a heating valve.

In addition, other carriers, such as gas, oil, etc., can be provided as the carrier for the energy that is consumed in the energy load 7.

The functioning of the arrangement shown in FIG. 1 shall be described below as an example with reference to its use in a hotel room.

The guest of a hotel room enters his room and pushes his hotel key into the transmitting device 10. In this way, primary energy, namely kinetic energy is released, which is converted into electrical energy. Then the transmit unit 3 generates a signal, which is emitted via the antenna as a radio signal and is captured by the receiving antenna 4 and transferred by the receiving device 5 into an electrical signal. This signal is supplied to the control device 6, which then applies, for example, the operating voltage supplied from the power supply 8 to ceiling lamp 7, par example by a not shown switch, so that this is illuminated. In this way, it is possible for the optionally illustrated sensor 9 to monitor the room lighting and to forward a corresponding signal to the ceiling lamp 7 and/or to the control device 6, so that the lamp 7 is illuminated only when there is not a certain level of background lighting in the room. Alternatively, the light can also be dimmed based on the brightness level measured by the sensor element 9, so that a certain brightness level is produced in the hotel room.

In this way, unnecessary turning-on of the light for sufficient brightness in the room is prevented.

When leaving the room, the hotel guest takes his key device out of the transmitting device 10, so that energy is again supplied to the energy converter 2, and another signal is transmitted via the transmit unit 3 and the transmitting antenna 1 as a radio signal, so that the receive unit 5 receives this signal via the receiving antenna 4 and supplies it to the control device 6, so that the ceiling light 7 is switched off, in that the control unit 6 no longer continues to supply the supply voltage 8 to the ceiling light 7.

Alternatively an arrangement is possible in the form that the withdrawal of the key from the transmitting device 10 is detected and by means of stored energy in the transmitting device 10 the signal described before is produced.

FIG. 2 shows a similar arrangement, wherein identical parts are not described again for avoiding repetition. In contrast to FIG. 1, the energy supply 8 is supplied directly to the energy load 7 and the signal received by the receiving device is supplied to the load 7. Accordingly, the load 7 is provided with an internal controller 6, which controls the energy consumption. This means, for example, that when the energy load 7 realized as a heater, that a switch-on signal is transmitted from the receiver 6 to the heater 7, wherein the energy consumption is controlled according to a heating value set in the internal controller 6.

It is also conceivable for the radio signal transmitted by the transmitting device 10 to contain information on the consumption value to be set for the energy load 7. In application, this can mean that, for example, when service personnel enter the hotel room and place their key device in the transmitting device 10, a different radio signal is transmitted to the receiver than when a normal hotel guest uses the room, so that, for example, the lights are set at a maximum value, in order to be able to better inspect the accommodations, which is possibly not necessary for a hotel guest. In this way, the heating output can be set, for example, to a maximum value, in order to be able to quickly check the functioning of the heater.

This means that it is provided that the value of the energy consumption or the value of the energy consumption to be set or to be regulated is contained in the radio signal or only identity information, i.e., e.g., service personnel or guest, is evaluated from this information and is assigned to appropriate energy consumption.

These many constructions, which were explained above in connection with the representation of FIG. 2, obviously can also be applied to the arrangement from FIG. 1.

Furthermore, in FIG. 2 a central control device 117 is shown, which can be realized, for example, by a PC or a special data-processing device that is optionally connected to the receiving device. This option shall be described below.

If the receiving device 5 receives the radio signal via the receiving antenna 4, then this is transmitted to the central control device 117. This means that, using the example of a hotel room, the hotel management knows that someone is in the room. If there are different key devices for the guest and for the service personnel or if a radio signal signifying the identity of the person is transmitted for different persons, then this information is forwarded to the central control device. This means that the hotel management or reception knows that someone is in the room and that the person is a service worker or the guest. Here, there is also the possibility that it is recognized that the person is the guest assigned to this room.

If only certain people are to be permitted to switch on the energy load, that is, the light in a hotel room, then such authorization must be stored either in the transmitting device 10 or in the receiving device 20, that is, programmed and also checked. Through the previously described option, that is, the connection to a central control device, the identity information can be transmitted to the central control device, the authorization is checked there, and the authorization will be transmitted to the receiving device.

This option creates a clearly higher flexibility, because the authorization can be controlled, and also monitored centrally in this way. Obviously, this option, namely the connection to a central control device, can also be applied to the construction from FIG. 1. In both cases, it is also possible for the central control device to be connected directly to the control device 6.

Above, where an application in a hotel room was described, it is understandable that a plurality of different further applications is also conceivable, e.g., for controlling a load in a laboratory space, large office, etc.

FIG. 3a shows a block diagram of a transmitting device 10, in which the key device is inserted in the form of a card 11. Such cards are already typical in hotels today, wherein a coded magnetic strip 20 is used to check the authorization when entering the hotel room and to release the hotel room door lock.

In FIG. 4a the transmitting device 10 is shown in a lateral cross section. The transmitting device is provided with a front flap 13 and a base housing 10a. The front flap 13 is connected to the base housing by means of a shaft 14 and a spring 15. If the card 11, which is not shown in FIG. 4, is inserted between the flap 13 and the base, then a slot 12 is formed, because the flap 13 is moved in the direction of the arrow away from the base about the rotational shaft 14 against the spring force 15. Through this motion, the flap 13 pushes with its end against the lever 116, this activates an electromechanical energy converter 2. This means that by pushing in the card 11, mechanical energy is supplied to the electromechanical energy converter 116 via the flap 13 and the lever 116. There it is converted into electrical energy, which is supplied via not-shown lines to a transmit unit 3. Here, for the sake of clarity, the representation of the transmitting antenna 1 is also eliminated.

If the card 11 is pulled out of the transmitting device 10, then the spring 15 lets the flap 13 move back against the base, wherein the lever 116 is moved back and thus mechanical energy is also supplied to the electromechanical energy converter.

According to FIG. 4b an alternative construction is shown. The front flap 13 is arranged with a distance against the base housing 10a so that the slot 12 is formed in which the not shown card is inserted. The inserted card pushes a bendable transfer element 117, which is movable within the slot 12 around the shaft 14, against the lever 116 of the energy converter 2. As a measure of this the transfer element 117 transfers kinetic energy which is supplied via the card to the lever 116. The further transformation of kinetic energy into electrical energy is realized as described with reference to FIG. 4a.

According FIG. 4c a further construction is shown which is similar to FIG. 4b. According FIG. 4c the lever 116 extends into the slot 12. By inserting the card into the slot 12 the lever 116 is moved by the card. The lever 116 is connected to the electromechanically converter 2 in which the kinetic energy of the lever 116 is converted into electrical energy.

While in the arrangements of the FIGS. 4a, 4b and 4c same reference symbols refer to comparable elements it is common the represented arrangements that by pushing a card body into the transmitting device 10 kinetic energy is produced, which is supplied to the electromechanical converter 2 and converted there into electrical energy.

It is easy to recognize that many comparable solutions can be achieved, which correspond to the same principle.

Such an arrangement according to one of the FIGS. 4a to 4c can be realized not only with the card shown in FIG. 3a or 3b, but also just as well with a classic key. Here it is essential that the insertion motion of the key, card, or three-dimensional key body supplies mechanical energy, which is converted into electrical energy in the energy converter 2. If a mechanical lock proves its authorization, for example, to activate the transmitting device through its shape relative to a lock, then a card can also be shaped accordingly by means of mechanical coding, for example, by opening that engage in pins. This is indicated in FIG. 3b. Here the card 11 has two openings 112, while the transmitting device has two pins 111, which extend through the openings 112 when a card 11 is inserted. This can mean that, for example, when the openings are in the wrong position, the card cannot be inserted sufficiently far into the transmitting device, so that no or insufficient energy is generated for transmitting a radio signal. It is possible just as well to provide the openings in the form of holes in the card, so that the pins 111 are pressed downward when the card is inserted into the transmitting device by the pins 110 and project through the openings 112 for an approved card and move back into their original position. In this way, mechanical energy is also provided by the pins 111, which can be converted into electrical energy.

These statements suggest only two constructions, which make it easy to show the multitude of possibilities on how the transmitting device and the key device can be constructed.

According to FIG. 5, another construction is shown in the form that the card 11 is inserted into a card guide 18, with which a magnet 17 is connected, which is moved, in turn, in a coil 16. Upon pushing the card 11 downward, the coil is moved in the direction of the arrow, so that mechanical energy is converted into magnetic energy and this is converted in turn into electrical energy. The electrical energy provided at the coil is supplied to a power supply circuit 19, which drives, in turn, the transmit unit 3. This is also only a block diagram; detailed constructions are obvious to someone skilled in the art.

The embodiment shown in FIG. 5 is improved in FIG. 6. Here, the card 11 has a semiconductor chip 114, in which information is stored. By means of an interface 113 the information stored in the chip-card chip 114 can be read from the reading device 115. The interface 113 can be both a contacting and also a contact-less interface. This means that the card 110, in the case that it involves a contacting interface, has contact surfaces with which counter contacts of the interface 13 are in contact in the inserted state. Such arrangements are already known in typical chip cards.

If this involves a contact-less interface, the interface and the card are constructed according to known RFID technology.

In such an arrangement, the cards can be individualized easily and provided with additional information, so that the card can contain not only information about the identity of the holder, but also additional information on its authorization. In the individual case, this means that the card contains information.

According to FIG. 6, the reading device is arranged between the power supply circuit and the transmitting device 3. This means that only in the case that the reading device 115 determines authorization by means of the information read from the chip-card chip, the power supply voltage is switched through to the transmit unit 3 or this supply is prevented if there is no authorization. However, this arrangement, as shown with dashed lines, can also be bypassed, when, as already explained with reference to FIGS. 1 and 2, the authorization is checked in the receiving device or in the central control device connected to the receiving device.

As an alternative to the electromechanical energy converter, which comprises an electromagnetic energy converter, an electromechanical energy converter can also be used with a piezoelectric element. Here, the person skilled in the art is obliged to provide appropriately adapted arrangements.

As alternatives to the electromechanical energy converter, other energy converters are also conceivable. For example, the use of a solar cell or photocell for a hotel room is also conceivable. In many cases, it is stipulated that emergency lighting is switched on also when no one is in the room, that is, the key device is not inserted into the transmitting device. Such emergency lighting could illuminate, for example, a solar cell, which then can be covered when no key device is inserted into the transmitting device. If the solar cell is exposed by inserting the key device, then light illuminates the solar cell and the light is converted in the solar cell into electrical energy.

Such devices also fall under the concept of the invention.

1. A control arrangement comprising:
a transmitting device and a receiving device, wherein the receiving device includes a receive unit, a control device, and an energy consumer and the transmitting device includes an energy converter, which converts primary energy into electrical energy, and a supplying device, which supplies the primary energy to the energy converter, and a transmit unit, wherein the converted energy is provided for operating the transmit unit, which transmits information to the receiving device, and wherein the supplying device is adapted to be activated by means of a key device and the receiving device is connected to the control device and the energy load, such that the control device controls the energy consumption of the energy load based on the reception of the information.

2. The arrangement according to claim 1, wherein the transmitting device has a locking device, to which the key device is assigned, wherein the locking device is constructed, such that the energy consumption is controlled only when the key device assigned to the locking device activates the supplying device.

3. The arrangement according to claim 2, wherein the energy converter converts mechanical energy into electrical energy.

4. The arrangement according to claim 3, wherein the energy converter includes an electromagnetic energy converter.

5. The arrangement according to claim 3, wherein the energy converter includes a piezoelectric element.

6. The arrangement according to claim 1, wherein the control device controls the energy supplied to the load.

7. The arrangement according to claim 6, wherein the receiving device includes a sensor device, which makes a control signal available to the control device.

8. The arrangement according to claim 2, wherein the locking device includes a reading device, which reads information stored in the key device.

9. The arrangement according to claim 2, wherein the locking device includes a mechanical lock, which prevents the activation of the supplying device with a key device not assigned to this locking device.

10. A method for controlling energy consumption comprising the steps of:
providing a key device to allow a supply of primary energy;
converting the primary energy into electrical energy;
generating information with the electrical energy and transmitting the information as a radio signal; and
receiving the radio signal for controlling energy consumption.

11. The method according to claim 10, wherein the energy is converted only when the key device has been checked for authorization.

12. The method according to claim 8, wherein the information is transmitted only when the key device has been checked for authorization.

13. The method according to claim 10, wherein the energy consumption is controlled after authorization information has been received.

14. The method according to claim 10, wherein the received information is forwarded at least partially to a central data-processing unit.

15. The method according to claim 10, wherein, when information is received, the energy consumption is set at a predetermined value.

16. The method according to claim 10, wherein, when information is received, the energy consumption is set at a value transmitted with the information.

17. An arrangement comprising:
an energy converter, which converts primary energy into electrical energy;
a key device, which includes an electronic memory device, in which information is stored;
a reading device, which reads the information from the memory device; and
a transmitting device, which is constructed, so that when supplying primary energy, additional information is transmitted, which is received by a receiving device of the arrangement allocated to an energy load, and controls the energy consumption of the energy load.

18. The arrangement according to claim 17, wherein the reading device reads the information from the memory device of the key device via a detachable contact.

19. The arrangement according to claim 15, wherein the reading device reads the information via a contact-less interface from the memory device of the key device.
